(19) United States
(12) Patent Application Publication
(10) Pub. No.: US 2026/0051760 A1
(43) Pub. Date: Feb. 19, 2026

(54) METHOD FOR CHARGING AN ENERGY STORE OF A FIELD DEVICE AND FIELD DEVICE FOR CARRYING OUT THE METHOD

(71) Applicant: VEGA Grieshaber KG, Wolfach (DE)

(72) Inventors: Marius Isenmann, Biberach (DE); Patrick Moser, Seelbach (DE)

(21) Appl. No.: 19/103,128

(22) PCT Filed: Aug. 11, 2023
(86) PCT No.: PCT/EP2023/072294

§ 371 Date: Feb. 11, 2025

(30) Foreign Application Priority Data
Aug. 12, 2022 (DE) 10 2022 120 434.0

(51) Int. Cl. H02J 7/00; H02J 7/34; H02J 7/35

(52) U.S. Cl. CPC H02J 7/00712; H02J 7/342; H02J 7/35

(57) ABSTRACT

A method for charging an energy store of a field device having at least one charging current source and a control unit in which the charging current source loads the energy store of the field device with a charging current. A field device carrying out the method includes a chargeable energy store, at least one charging current source and a control unit. The useful life of the field device can be increased by the method and the field device according to the disclosure.

The invention relates to a method for charging an energy store of a field device having at least one charging current source and a control unit, wherein the charging current source loads the energy store of the field device with a charging current.

Furthermore, the invention relates to a field device having a chargeable energy store, at least one charging current source and a control unit, wherein the field device is designed for carrying out the method.

Field devices of the aforementioned type are autonomous sensors in particular, which are designed for fill level measurement, limit level measurement, separation layer measurement and the measurement of flow rates of liquids and bulk material and also for measuring the pressure of liquids and gases. In this case, they can fulfil the relevant safety requirements to be able to be operated in areas with a potentially explosive atmosphere. To supply power to a measuring unit, the field device has an electrical energy store which can be charged by means of a charging current source which is part of the field device or is at least connected to the field device. The possible useful life of such a field device depends in particular on the service life of the energy store that is used. The object of the invention is therefore to propose a method and a field device, using which the useful life of a field device can be increased.

This object is achieved by the method according to Claim 1 and by the field device according to Claim 10. Preferred embodiments of the method and the field device are specified in the dependent claims.

According to an advantageous embodiment of the invention, it is provided that the energy store of the field device is a rechargeable battery. To lengthen its service life, the rechargeable battery is preferably charged to 80% maximum in relation to the whole of its battery capacity, which corresponds to an optimum charge.

It is self-explanatory that a different value that does not correspond exactly to 80% of the whole of the battery capacity may also be considered as an optimum charge. For example, 75% or 85% or 90% of the whole of the battery capacity may also represent an optimum charge in the sense of the present application.

In order to ensure the availability of a satisfactory charging current during the available charging time, it is provided, according to a preferred embodiment of the invention, that the field device has a plurality of different charging current sources, wherein the control unit specifies, whilst taking a prioritization into account, which charging current source or which combination of charging current sources loads the energy store of the field device with a charging current. Accordingly, the charging current sources are configured in such a manner that they provide the charging current in each case alone or in combination with one or more other charging current sources simultaneously. It is preferably provided in this case that the field device has as charging current sources at least a battery, a wired interface, such as a USB interface for example, and a solar cell. The battery is preferably replace-able and can be replaced at regular maintenance intervals. In the prioritization by the control unit, at least one or more of the following selection criteria is taken into account:
a) The charging current is then only applied by the battery as charging current source if no other charging current source is available ready-to-use. The energy drawn from the battery is preferably measured so that the battery can be replaced before the energy is consumed completely.
b) The charging current is then always applied by the solar cell as charging current source if charging of the energy store is possible. The solar cell is therefore always selected as charging current source if the solar cell generates a suitable charging current, which is dependent on the fluctuating and unforeseeable light conditions however. Here, the energy store is preferably charged to 80%, wherein this value can be adjusted in a variable manner.
c) The charging current can be applied by the wired interface as charging current source if the wired interface is connected to an external control device, wherein the energy store is preferably charged to more than 80%. The wired interface is for example connected to an external control device for para-metrizing the field device, for commissioning (initial set-up) of the field device and for tests or updates. The preferred charging of more than 80% takes place in this case so that after removal of the external control device, there is still sufficient energy available to finish the initiated process and the pending measurement routine. It is also hereby ensured that the battery is not required as charging current source for additional time, which increases the operational life of the device. The rather rare process of charging above 80% has no effect or at most slight effects on the service life of the energy store.
d) If a selected charging current source cannot apply the required electrical energy in order to charge the energy store of the field device at least sufficiently or optimally, the maximum possible electrical energy is drawn from the selected charging current source for charging the energy store of the field device and one of the other charging current sources is selected for further charging of the energy store of the field device.

Alternatively to an automatic prioritization by means of the control unit, the selection of the charging current source and thus the prioritization can also take place manually. The automatic prioritization can in the simplest case take place by switching off the charging current sources that are not required (in particular dis-connect ICs, open MOSFETs or switches). Furthermore, the charging current source that instantaneously delivers the highest charging voltage can also be selected in each case, for which reason suitable diodes only let the higher voltage through, in order to unload the comparatively lower voltage.

In the context of a further preferred embodiment of the invention, it is provided that the charging of the energy store of the field device takes place in a manner that depends over time on the (active) operating times of the field device, wherein the charging of the energy store preferably takes place during a time period that lies between two (active) operating times of the field device, wherein use is preferably made of this time period for as long as possible for charging the energy store. In other words, the rechargeable battery is preferably loaded with the lowest possible charging current that is required to charge the rechargeable battery during the available time. If, for example, the field device is a measuring device and measurement is carried out at regular intervals of 12 h, the charging takes place during the 12-hour rest phase of the field device, which allows a careful charging of the energy store. The charging current is lowered such that the optimal use is made of the rest phase to charge the energy store.

A careful charging of the energy store should in the present case be understood as charging with a lowest possible charging current. Independently of the fact that a maximum permitted charging current should not be exceeded, the charging current is therefore kept as low as possible for a careful charging.

Due to the automatic or manual prioritization, it is also ensured that the rechargeable battery is charged with the optimum or maximum possible charging voltage, wherein the charging is carried out as carefully as possible.

As unexpected events, such as for example external triggers, particularly a button press by a customer or a signal of a different device, can interrupt the rest phase, it is advantageous to charge the energy store as fast as possible at the start of rest phase. As soon as sufficient energy is present for one or more activities of the device, particularly for measuring and/or for data transmission, the charging current is reduced, so that the rechargeable battery is charged as carefully as possible, as described previously.

During charging of an energy store, a maximum permitted charging current must not be exceeded, wherein the maximum permitted charging current is generally temperature-dependent. The temporal course of the charging current and its current intensity influences the service life of an energy store, particularly the number of possible charging cycles. According to experience, the charging current is set up to be as low as possible, but as large as necessary. In order not to exceed the maximum permitted charging current, current limiters in the form of fuses, passive resistances or active resistances (OP AMPs, semiconductors, MOSFETs and the like) are known in the case of known field devices. The relevant charging current sources usually have a constant charging voltage and generate this by means of a connected, variable resistance on a constant charging current. At a low voltage level of the energy store to be charged, the difference of the voltages between the charging current source and the energy store sometimes leads to the current limitation being activated, as a result of which, in the resistance in particular, electrical energy is converted into heat in an unnecessary manner and is consequently lost. According to an advantageous development of the invention, it is therefore provided that the at least one charging current source is connected to a voltage regulator which regulates the charging voltage in such a manner that the maximum permitted charging current is not exceeded. In one embodiment, the charging current can however also be adjusted such that it is as close as possible to the maximum permitted charging current, in particular corresponds to the same. Thus, a lowest possible loading of the charging current source can be achieved. In this case, the charging voltage is preferably adjusted depending on the instantaneous voltage of the energy store and/or depending on the instantaneous charging current. In this manner, a very energy-efficient charging of the energy store is achieved, as due to the regulation of the charging voltage, an additional current limitation is not necessary or present but not active, as the maximum permitted charging current is not exceeded.

In this case also, a particularly careful charging of the energy store can be achieved if the charging current is kept as low as possible. This is possible in particular if the time period for a charging of the energy store, i.e. the time period until an instant at which the energy store must have a predetermined charge, is known. If this time period is known, the charging current is regulated in one embodiment by means of a regulation of the charging voltage such that it is minimal over the entire time period.

Alternatively, as described above, it may be provided that a predeterminable charge of the energy store is reached as fast as possible and therefore using a charging current which is as close as possible to the maximum permitted charging current, and starting from when this predetermined charge is reached, the charging current is reduced to the minimum possible charging current for the calculated time period for achieving the optimum charging.

In an actual embodiment, there is a linear “balancing curve”, so the charging voltage in the region considered is greater than the instantaneous voltage of the energy store by a constant value. Should the energy store have a voltage of 2.5 V for example, then the charging circuit generates an output voltage of 3 V for example. With each increase of the instantaneous voltage of the energy store, the output voltage of the charging current source is also increased equally until a target voltage of 3.9 V is reached at the charging current source. If the voltage of the energy store reaches a value of the target voltage of 3.9 V, no further charging current can flow and the final charging voltage is reached. For the most part, between the output of the charging circuit and the energy store, there is a resistance value which is known approximately and which results in particular from the resistance value of a fuse, a measuring resistor of a current limitation, etc. As the voltage of the charging circuit and the voltage of the energy store are known, the maximum charging current can be determined. For current limitation, switched semiconductor components are preferably used, which in the context of an advantageous embodiment have Zener diodes. In this manner, a particularly fast and simultaneously energy-efficient charging of the energy store is achieved.

A combination of an energy-efficient and careful charging of the energy store can for example be achieved using the previously mentioned actual embodiment if charging is carried out according to the specified balancing curve up to a specified voltage of the energy store and when the specified voltage is reached, the charging current is adjusted to the minimum possible charging current with which the optimum charge or a full charge of the energy store of the field device can be achieved in the remaining time period.

Independently of the voltage regulation, voltage limiting also takes place in the context of a preferred embodiment of the invention, for which reason a voltage limiter is provided. A voltage limiter consumes energy even at low voltages of the charging current source, for example in the form of leakage currents, even if the voltage at the energy store to be charged is below the maximum voltage to be limited. In order to avoid an unnecessary loss of energy in this case, it is provided according to a further advantageous development of the invention that the voltage limitation is first activated when the voltage of the energy store has exceeded a minimum voltage and deactivated when the voltage of the energy store has fallen below a minimum voltage. If a maximum voltage of 4.0 V is allowed at the energy store for example, the voltage limitation is only activated by means of suitable Zener diodes from a voltage of for example 3.7 V. As a result, small leakage currents only flow through the voltage limitation above a charging voltage of 3.7 V. A periodic activation and deactivation (what is known as clocking) can be avoided by the early activation of a Zener diode and a suitable hysteresis.

The circuit for voltage limitation that is described is advantageous in particular for batteries as charging current source, because the available energy is limited. If the charging voltage is regulated such by the voltage regulator that the current limitation remains deactivated, no unnecessary energy is consumed, which has a beneficial effect on the useful life of the field device. If the energy store is however charged by a charging current source in which energy is present to a sufficient or uncritical extent, as for example in the case of a wired interface or a solar cell, a comparatively higher charging voltage may be sensible and losses of electrical energy can be ignored in the context of the current limitation. Thus, the use of a voltage regulator and the activation of the voltage limitation from a certain voltage value is particularly preferable if a battery is used as charging current source.

Finally, it is preferably provided that the voltage regulator is activated if the voltage of the charging current source has exceeded a minimum voltage.

Actual embodiments of the invention are explained in the following with reference to the figures. In the figures:

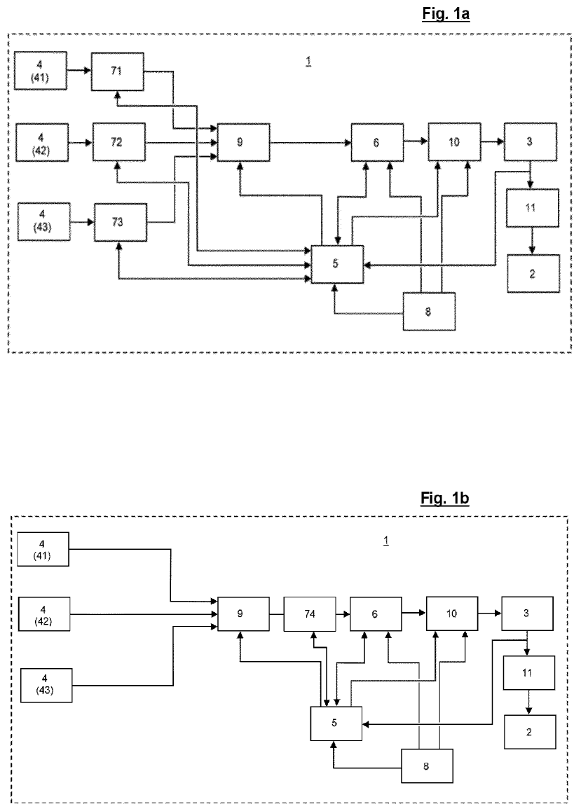

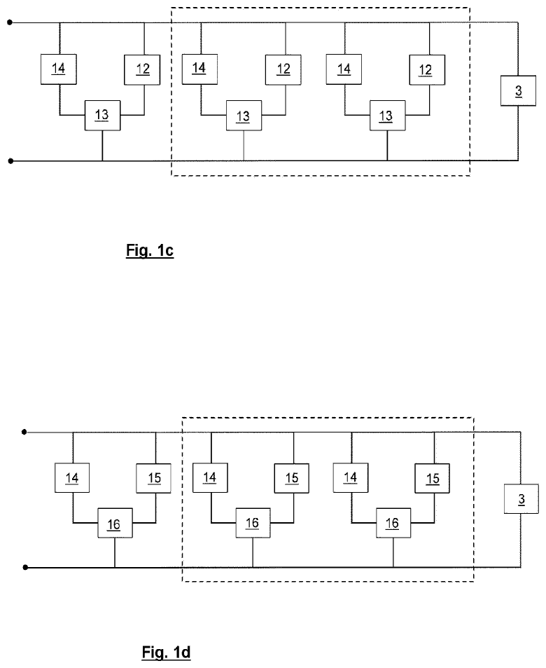

FIGS. 1a, b in each case show a field device,

FIGS. 1c-f in each case show a voltage limiter, and

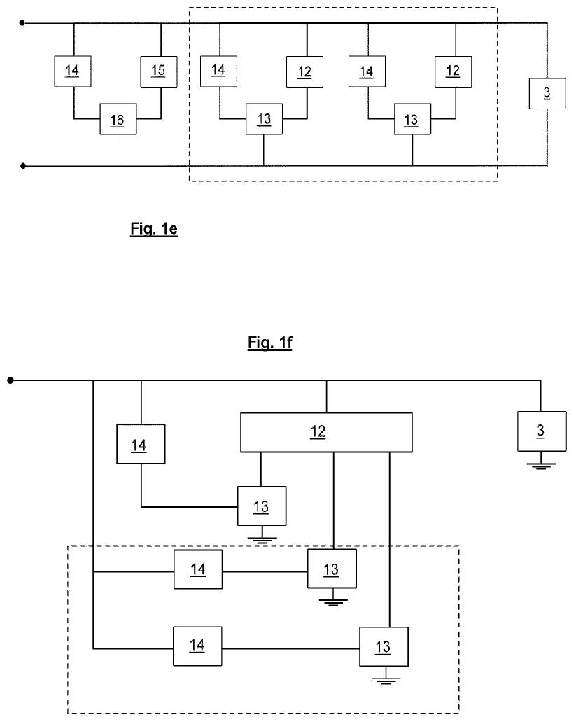

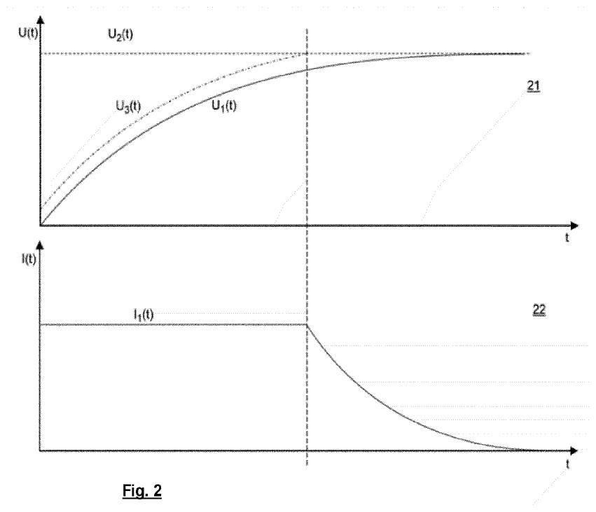

FIG. 2 shows the charging behaviour of an energy store in two graphs.

FIG. 1a shows a field device 1 in schematic illustration, which has a load in the form of a measuring device 2. Such a measuring device 2 is a fill level measurement device for example. An energy store 3 is provided to supply energy to the measuring device 2, which energy store is a rechargeable battery in the exemplary embodiment illustrated. To charge the energy store 3, the field device 1 has three charging current sources 4, namely a battery 41, a solar cell 42 and a wired interface 43 in the form of a USB interface. The charging current sources 4 are at least indirectly connected to a control unit 5 which is in turn connected to the energy store 3 and obtains information about the charging voltage. Furthermore, the control unit 5 is also connected to a current limiter 6 which transmits the value of the instantaneous charging current to the control unit 5. If for example, owing to a pending measurement routine, charging of the energy store 3 is required, a prioritization of the charging current sources 4 takes place, which is controlled by the control unit 3, wherein which of the charging current sources 4 is used to apply a charging current is selected on the basis of specified criteria. In the prioritization by the control unit 5, at least one or more of the following selection criteria is taken into account:
a) The charging current is then only applied by the battery 41 as charging current source 4 if no other charging current source 4 is available ready-to-use.
b) The charging current is then always applied by the solar cell 42 as charging current source 4 if charging of the energy store 3 is possible.
c) The charging current can be applied by the wired interface 43 as charging current source 4 if the wired interface 43 is connected to an external control device, wherein the energy store 3 is preferably charged to more than 80%.
d) If a selected charging current source 4 cannot apply the required electrical energy in order to charge the energy store 3 of the field device 1 at least sufficiently or optimally, the maximum possible electrical energy is drawn from the selected charging current source 4 for charging the energy store 3 of the field device 1 and one of the other charging current sources 4 is selected for further charging of the energy store 3 of the field device 1.

As a result, it is possible to select the charging voltage 4 which enables a charging of the energy store 3 that is as energy-saving and/or careful as possible.

In the illustrated exemplary embodiment, the charging current sources 4 are in each case connected to a voltage regulator 71, 72, 73. The voltage regula-tors 71, 72, 73 in the present case are designed as a voltage generating circuit in such a manner that, depending on the instantaneous voltage of the energy store 3 and/or the instantaneous charging current, the charging voltage is adjusted in such a manner that the charging current, even without the controlling/regulating intervention by the current limiter 6, does not exceed the maximum charging current. The regulation of the charging voltage preferably takes place in a tempera-ture-dependent manner, for which reason the field device 1 has a temperature sensor 8.

As additional components, the field device 1 in the illustrated exemplary embodiment has a decision maker/comparator 9 which forms a charge protection in the case of too low a voltage at the energy store in order to avoid recharging following total discharge. Furthermore, the field device 1 has one or more further voltage limiters 10, which is/are connected between the voltage limiter(s) 6 and the energy store 3, and a total discharge protection 11, which prevents charging from taking place anew after the total discharge, rather it ensures that the situation of total discharge does not occur in the first place.

FIG. 1b shows an exemplary embodiment that is substantially identical compared to FIG. 1a, in which exemplary embodiment the charging current sources 4 are initially connected to the decision maker/comparator 9 and subsequently to a voltage regulator 74 however.

FIGS. 1c-f show different embodiments of a voltage limiter 10 which in each case is activated when the voltage of the energy store 3 has exceeded a minimum voltage and is deactivated when the voltage of the energy store 3 has fallen below a minimum voltage.

According to FIG. 1c, a Zener diode 12 and a controllable switch 13 are connected parallel to the energy store 3 for voltage limitation, wherein the controllable switch 13 is connected to a voltage comparator 14. For reasons of redundancy and to fulfil any safety requirements, this component combination of Zener diode 12, controllable switch 13 and voltage comparator 13 is additionally realized twice (framed in a dashed box) in an identical manner, which includes a functional safe-guard if one of the first-mentioned components fails.

According to FIG. 1d, a resistor 15 and a controllable semiconductor 16 are connected parallel to the energy store 3 for voltage limitation, wherein the controllable semiconductor 16 is connected to a voltage comparator 14. Here also, the aforementioned components are parallel-connected three-times in total in an identical manner, in order to maintain the ability to function in the event of a fault.

FIG. 1e shows an embodiment of a voltage limiter 10 in which different components are provided for voltage limitation. First, a resistor 15 is connected together with a controllable semiconductor 16 parallel to the energy store 3, wherein the controllable semiconductor 16 is connected to a voltage comparator 14. Furthermore, two further identical component combinations are provided, according to which in each case a Zener diode 12 and a controllable switch 13 are connected parallel to the energy store 3, wherein the controllable switch is connected to a voltage comparator 14 in each case.

FIG. 1e shows an exemplary embodiment which is substantially functionally identical to FIG. 1c, wherein the controllable switches 13 are connected to a common Zener diode 12 in each case.

FIG. 2 shows a typical charging behaviour of the energy store in two graphs 21, 22. Graph 21 shows the voltage U(t) at the energy store as a function of time t and graph 22 shows the charging current I(t) as a function of time t. Assuming a constant charging current I₁(t), the voltage at the energy store increases slowly. A higher voltage at a constant charging current I₁(t) increases the consumed power of the energy store, which is why the voltage U₁(t) typically always increases more slowly. If a charge regulator then charges with a constant voltage U₂(t), a current limitation would only take place by means of the internal resistance of the energy store and the charging current would exceed the maximum permitted charging current. Therefore in this case, a current limitation which incurs losses would be required in this case, which reduces the charging voltage U₂(t) until the sufficiently low charging current I₁(t), which is limited by the internal resistance, flows. The at least one current limiting circuit may be absolutely necessary in spite of this however for reasons of technical explosion protection and introduces an additional resistance into the charging circuit. With the aid of these known resistances or by means of a measurement, a charging voltage U₃(t) can be calculated at the voltage regulator, which is chosen such that the desired charging current I₁(t) flows.

### LIST OF REFERENCE SIGNS

1 Field device
2 Measuring device
3 Energy storage device
4 Charging current source
41 Battery
42 Solar cell
43 Wired interface
5 Control unit
6 Current limiter
71 Voltage regulator
72 Voltage regulator
73 Voltage regulator
8 Temperature sensor
9 Decision maker/comparator
10 Voltage limiter
11 Total discharge protection
12 Zener diode
13 Controllable switch
14 Voltage comparator
15 Resistor
16 Controllable semiconductor
21 Graph
22 Graph
I(t) Charging current
U(t) Charging voltage
t Time

1. A method for charging an energy store of a field device having at least one charging current source and a control unit, wherein the charging current source loads the energy store of the field device with a charging current.

2. The method according to claim 1, wherein the energy store of the field device is a rechargeable battery, wherein, to lengthen its service life, the rechargeable battery is charged to 80% maximum in relation to the whole of its battery capacity.

3. The method according to either of claim 1, wherein the field device has a plurality of different charging current sources, wherein the control unit specifies, whilst taking a prioritization into account, which charging current source or which combination of charging current sources loads the energy store of the field device with a charging current.

4. The method according to claim 3, wherein the field device has as charging current sources at least a battery, a solar cell and a wired interface, wherein in the prioritization by the control unit, at least one or more of the following selection criteria is taken into account:
a) the charging current is only applied by the battery as charging current source if no other charging current source is available ready-to-use;
b) the charging current is always applied by the solar cell as charging current source if charging of the energy store is possible;
c) the charging current can be applied by the wired interface as charging current source if the wired interface is connected to an external control device, wherein the energy store is preferably charged to more than 80%; and
d) if a selected charging current source cannot apply the required electrical energy in order to charge the energy store of the field device sufficiently, the maximum possible electrical energy is drawn from the selected charging current source for charging the energy store of the field device and one of the other charging current sources is selected for further charging of the energy store of the field device.

5. The method according to one of claim 1, wherein the charging of the energy store of the field device takes place in a manner that depends over time on the operating times of the field device, wherein the charging of the energy store preferably takes place during a time period that lies between two operating times of the field device, wherein use is preferably made of this time period for as long as possible for charging the energy store.

6. The method according to one of claim 1, wherein to ensure an orderly operation, the charging current is only reduced after a minimum energy in the energy store is achieved.

7. The method according to one of claim 1, wherein the at least one charging current source is connected at least indirectly to a voltage regulator which regulates the charging voltage in such a manner that the maximum permitted charging current is not exceeded.

8. The method according to one of claim 1, wherein the charging voltage is adjusted depending on one or more of the instantaneous voltage of the energy store and the instantaneous charging current.

9. The method according to one of claim 1, wherein, by means of a voltage limiter, a voltage limitation
a) is activated when the voltage of the energy store has exceeded a minimum voltage, and
b) is deactivated when the voltage of the energy store has fallen below a minimum voltage.

10. The method according to one of claim 1, wherein the voltage regulator is activated when the voltage of the charging current source has exceeded a minimum voltage.

11. A field device having a chargeable energy store, at least one charging current source and a control unit, wherein the field device control unit is programmed to carry out the method according to claim 1.
